(19) United States
(12) Patent Application Publication
(10) Pub. No.: US 2016/0139645 A1
(43) Pub. Date: May 19, 2016

(54) COMPUTING SYSTEM AND POWER-ON METHOD AND UPDATING METHOD

(71) Applicants: Inventec (Pudong) Technology Corporation, Shanghai (CN); Inventec Corporation, Taipei City (TW)

(72) Inventor: Ying-Xian HAN, Shanghai (CN)

(21) Appl. No.: 14/596,061

(22) Filed: Jan. 13, 2015

(30) Foreign Application Priority Data
Nov. 14, 2014 (CN) 201410647417.7

(51) Int. Cl. G06F 1/30; G06F 1/32

(52) U.S. Cl. CPC G06F 1/30; G06F 1/3293; G06F 1/3246; G06F 1/3296

(57) ABSTRACT

In the power-on method with the computing system, when a first logic unit of a logic module is powered normally, the logic module is provided to transmit an available power-control-signal to a power conversion unit to make the power conversion unit transmit a working power to a second logic unit of the logic module. In the updating method with the computing system, a processing module is provided to receive an updating instruction to update the logic module. When the logic module is fail to be updated, the logic module transmit an invalid power-control-signal to the power conversion unit to make the power conversion unit transmit stop generating the working power, and then the logic module is updated by the processing module with a firmware update information stored in a storage. After updating by the processing module, the second logic unit of the logic module receives the working power again.

### FIELD OF THE INVENTION

The present invention is related to a computing system as well as the power-on method and the updating method thereof, and more particularly related to the computing system as well as the power-on method and the updating method featuring two-steps power-on and updating processes.

### BACKGROUND OF THE INVENTION

Attending with the progress of technology, the development of network has made our daily lives full of electronic devices. The computing system, such as the server, is a fundamental apparatus for establishing a network, and it is a necessary for the computing systems nowadays to update the firmware so as to maintain a good operating efficiency.

However, restricted by the design of power supply circuit nowadays, the electric power would be comprehensively supplied to the computing system when the computing system is powered which is likely to generate leaky current when using the computing system. In addition, the unexpected power-off of the computing system during the updating process may result in updating failure such that the computing system may not be smoothly started then. Accordingly, there exists the need to improve the computing systems in present.

### BRIEF SUMMARY OF INVENTION

Under the restriction of power supply circuit design, the computing system in present encounters the problem of leaky current when being powered on and the problem of unable to be started smoothly as the updating process is failed. Accordingly, a computing system as well as the power-on method and the updating method thereof is provided in accordance with the present invention, which has the feature of two-steps power-on and updating process, to resolve the problems.

According the above mentioned object, a computing system is provided in accordance with an embodiment of the present invention. The computing system comprises a power supply unit, a power conversion unit, at least a logic module, a storage unit, and a processing module. The power supply unit is utilized for receiving a system power and generating a first working power. The power conversion unit is electrically connected to the power supply unit and is utilized for receiving the first working power and outputting a second working power according to a power control signal. The logic module is electrically connected to the power supply unit and the power conversion unit and includes at least a first logic unit and at least a second logic unit. The first logic unit is powered by the first working power and the second logic unit is powered by the second working power. The storage unit is electrically connected to the logic module and stores at least an original predetermined firmware update information. The processing module is electrically connected to the logic module and the storage unit for updating firmware of the logic module according to an updating instruction.

Wherein, when the first logic unit is powered normally, the power-control signal transmitted from the logic module to the power conversion unit is valid to make the power conversion unit output the second working power, and the logic module is powered normally after the second logic unit receives the second working power. When the processing module receives the updating instruction, the processing module transmits an application firmware signal to update the logic module. As the logic module fails to be updated, the power control signal transmitted from the logic module transmits to the power conversion unit is invalid to make the power conversion unit stop generating the second working power, and then the logic module is updated by the processing module automatically with the predetermined firmware update information stored in the storage unit so as to transmit the valid power control signal to the power conversion unit to make the power conversion unit output the second working power. The logic module is powered normally after the second logic unit receives the second working power again.

In accordance with an embodiment of the present invention, the processing module is a baseboard management controller (BMC), the storage unit is a serial peripheral interface (SPI) read-only memory (ROM), and the logic module is a complex programmable logic device (CPLD).

In addition, a power-on method for a computing system is also provided in accordance with an embodiment of the present invention. The power-on method is utilized for powering on the above mentioned computing system. The power-on method determines whether the first logic unit is power normally or not first, as the determination result is yes, the logic module transmits the valid power control signal. The power conversion unit receives the valid power control signal so as to output the second working power. Finally, the second logic unit receives the second working power to make the whole logic module powered normally.

In accordance with an embodiment of the power-on method of the present invention, as the first logic unit is not powered normally, an alarm signal is transmitted to notify the user.

In addition, an updating method for a computing system is also provided in accordance with an embodiment of the present invention. The updating method is executed by the above mentioned computing system. In the beginning, the processing module receives the updating instruction and transmits the application firmware signal to update the logic module. Then, the method determines whether the logic module fails to update. If the determination result is yes, the logic module transmits the invalid power control signal. The power conversion unit receives the invalid power control signal so as to stop the second working power. Then, the processing module automatically updates the logic module with the predetermined firmware update information stored in the storage unit. Afterward, the logic module transmits the valid power control signal to the power conversion unit to make the power conversion unit output the second working power. Then, the whole logic module is powered normally after the second logic unit receives the second working power again.

By using the computing system as well as the power-on method and the updating method provided in accordance with the present invention, the problem of leaky current due to the comprehensive power-on process of the traditional computing system can be prevented because the present invention adopts the two-steps power-on process. In addition, the problem that the computing system cannot be smoothly started due to updating failure can be prevented because the present invention adopts the two-steps updating process, which can trigger the updating step to use the predetermining firmware information when encountering updating failure in the first step so as to enhance user's convenience.

The embodiments adopted in the present invention would be further discussed by using the flowing paragraph and the figures for a better understanding.

### BRIEF DESCRIPTION OF THE DRAWINGS

FIG. 1 is a block diagram showing the computing system in accordance with a preferred embodiment of the present invention;

FIG. 2 is a flow chart showing the power-on method of the computing system in accordance with a preferred embodiment of the present invention; and

FIG. 3 is a flow chart showing the updating method of the computing system in accordance with a preferred embodiment of the present invention;

### DETAILED DESCRIPTION OF THE INVENTION

There are various embodiments of the computing system as well as the power-on method and the updating method provided in accordance with the present invention, only a preferred embodiment is mentioned for each one in the following paragraph as an example, and the other variations of the preferred embodiment are not repeated hereby.

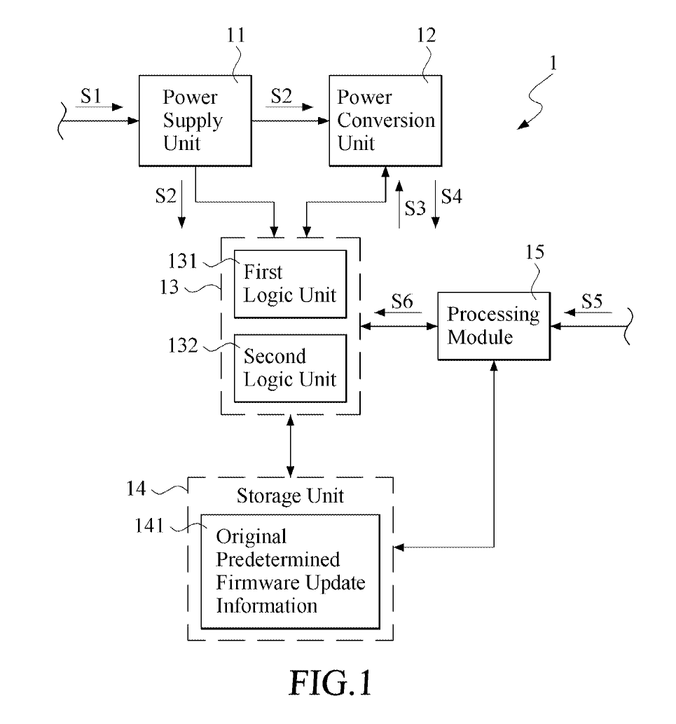

FIG. 1 is a block diagram showing the computing system in accordance with a preferred embodiment of the present invention. As shown, the computing system 1 includes a power supply unit 11, a power conversion unit 12, at least a logic module 13, a storage unit 14, and a processing module 15.

The power supply unit 11 is the power supply unit (PSU) of a computer, which can be electrically connected to the present commercial electricity system. The power conversion unit 12 is electrically connected to the power supply unit 11. The power conversion unit 12 may be composed of resistors, transistors (such as MOS transistors) and capacitors. However, the present invention is not so restricted. The other converters with power conversion capability can also be used in the present invention to replace the power conversion unit 12.

The logic module 13 can be a complex programmable logic device (CPLD), which includes at least a first logic unit 131 (only one is shown in the figure) and at least a second logic unit 132 (only one is shown in the figure). The first logic unit 131 and the second logic unit 132 can be made of the electric components of the complex programmable logic device, for example, the electric components such as the multiplexer and the logic gate can be used to compose the first logic unit 131 and the second logic unit 132. Concretely speaking, the logic module 13 in present usually includes a plurality of logic units (such as bank 1 to bank 8), and only two of them are shown in the present embodiment as an example.

The storage unit 14 is a serial peripheral interface (SPI) read-only memory (ROM) electrically connected to the logic module 13. However, the present invention is not so restricted. The other memories with data storing capability can be used in the present invention to replace the storage unit 14 of the present embodiment. In addition, an original predetermined firmware update information 141 is stored in the storage unit 14. The original predetermined firmware update information 141 is the factory default predetermined firmware update information, i.e. the most original version of the firmware.

The processing module 15 is electrically connected to the logic module 13 and the storage unit 14. The processing module 15 can be a baseboard management controller (BMC). However, the other processors with data processing capability can be used as the other embodiments of the present invention to replace the BMC.

The power supply unit 11 is utilized to receive a system power Si and generate a first working power S2. The system power S1 can be the power from the above mentioned commercial electricity system. The power conversion unit 12 receives the first working power S2 and outputs the second working power S4 according to a power control signal S3. In addition, in accordance with a preferred embodiment of the present invention, the first logic unit 131 is powered by the first working power S2 and the second logic unit 132 is powered by the second working power S4. The processing module 15 it utilized to update the firmware of the logic module 13 according to an updating instruction S5, which is triggered by the user (for example, the transmission of the updating instruction can be triggered by the electronic devices such as the cell phone, or through the input devices such as the keyboard).

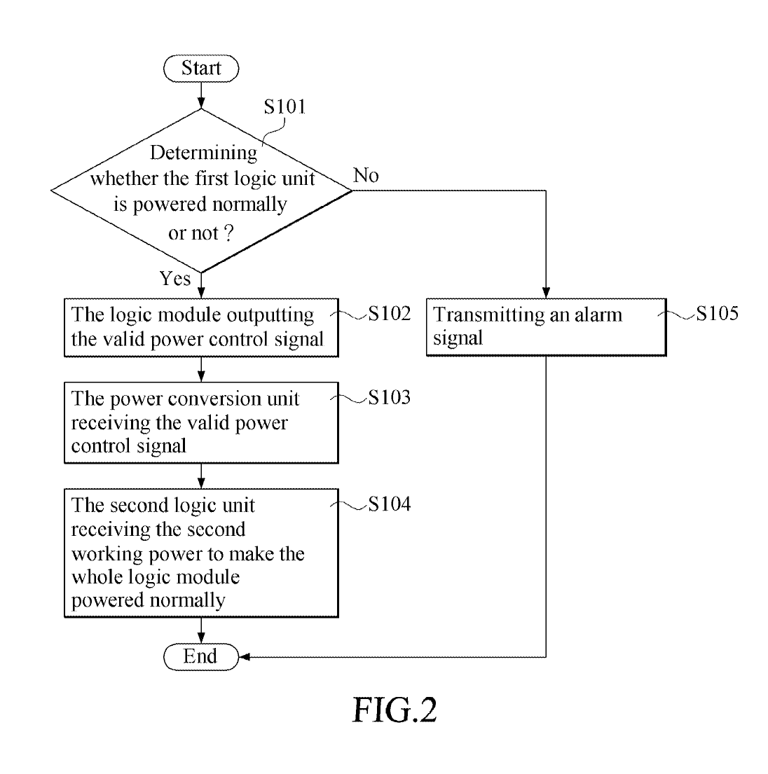

Please refer to FIG. 1 and FIG. 2, wherein FIG. 2 is a flow chart showing the power-on method of the computing system in accordance with a preferred embodiment of the present invention, the power-on method for powering on the computing system 1 includes the steps of:

Step S101: determining whether the first logic unit is powered normally or not;

Step S102: the logic module outputting the valid power control signal;

Step S103: the power conversion unit receiving the valid power control signal;

Step S104: the second logic unit receiving the second working power to make the whole logic module powered normally;

Step S105: transmitting an alarm signal.

In the beginning, the step S101 is carried out to determine whether the first logic unit 131 of the logic module 13 is powered normally or not. Concretely speaking, the determination may be executed by the logic module 13 itself. However, the present invention is not so restricted. For example, the processing module 13 can be used to execute the determination step by judging whether the logic module operates normally or not, whether the voltage level is stable or not, whether there exists any leaky current or not and so on in accordance with the other embodiments of the present invention.

As the determination result of the Step S101 is yes, the step S102 is executed in which the logic module 13 outputs the valid power control signal S3, and the valid power control signal S3 is a low level signal (LOW). To be more precisely, the power control signal S3 is a digital signal with a high level and a low level (i.e. the digital signal of 1 and 0). In accordance with the preferred embodiment of the present invention, the valid power control signal S3 is 0, and the invalid one is 1.

After the step S102, the step S103 is executed in which the power conversion unit 12 is triggered after receiving the valid power control signal S3 so as to convert the first working power S3 and output the second working power S4.

After the step S103, the step S104 is executed in which the second logic unit 132 receives the second working power S4 to make the whole logic module 13 powered normally, i.e. both the first logic unit 131 and the second logic unit 132 are powered normally, to make the computing system 1 operate smoothly.

On the other hand, as the determination result of the step S101 is no, the step S105 is executed to transmit an alarm signal, which can be an audio signal, a lighting signal, or an imaging signal to notify the user that the power supplied to the first logic unit 131 has an abnormal event.

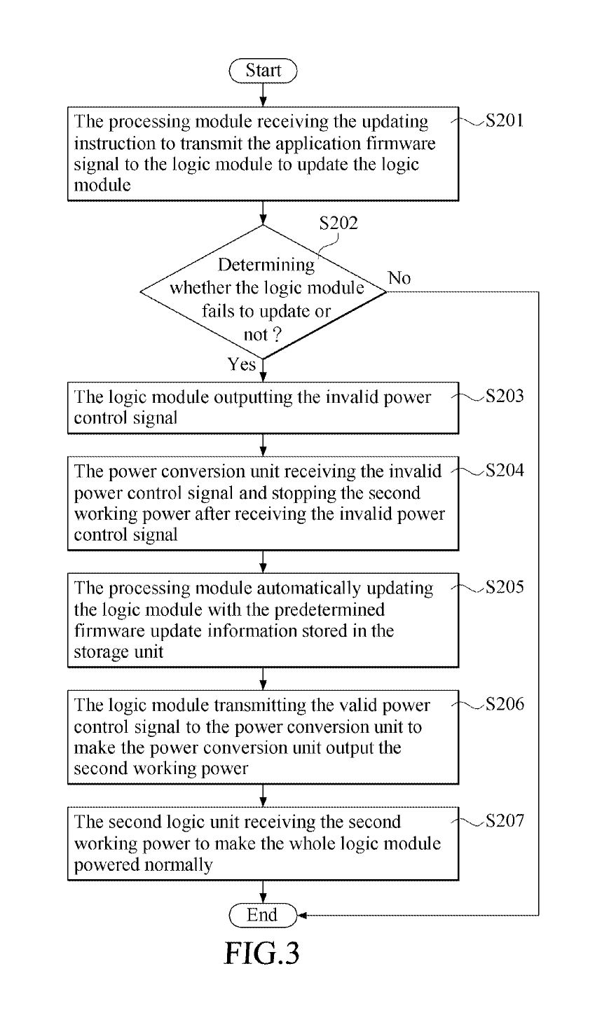

Please refer to FIG. 1 and FIG. 3, wherein FIG. 3 is a flow chart showing the updating method of the computing system in accordance with a preferred embodiment of the present invention, the updating method utilized for updating the computing system 1 includes the steps of:

Step S201: the processing module receiving the updating instruction to transmit the application firmware signal to the logic module to update the logic module;

Step S202: determining whether the logic module fails to update or not;

Step S203: the logic module outputting the invalid power control signal;

Step S204: the power conversion unit receiving the invalid power control signal and stopping the second working power after receiving the invalid power control signal;

Step S205: the processing module automatically updating the logic module with the original predetermined firmware update information stored in the storage unit;

Step S206: the logic module transmitting the valid power control signal to the power conversion unit to make the power conversion unit output the second working power; and

Step S207: the second logic unit receiving the second working power to make the whole logic module powered normally.

In the beginning, the step S201 is executed in which the processing module 15 receives the updating instruction S5 so as to transmit the application firmware signal S6 to the logic module 13 to update the logic module 13. The application firmware signal S6 may include the information of the firmware version with which the user wants to update.

Then, the step S202 is executed to determine whether the logic module 13 fails to update or not when updating the logic module 13. If the determination result is no, the process in ended; whereas, if the determination result is yes, the step S203 is executed in which the logic module 13 outputs the invalid power control signal S3. Similarly, the invalid power control signal is 1. In addition, in the present step, the processing module 15 can record the error information in the storage unit 14.

After the step S203, the step S204 is executed in which the power conversion unit 12 stops outputting the second working power S4 after receiving the invalid power control signal S3. That is, the logic module 13 cannot operate because there the power supply has an abnormal event. Then, the step S205 is executed in which the processing module 15 updates the firmware of the logic module 13 with the original predetermined firmware update information 141 stored in the storage unit 14 automatically. That is, as the logic module 13 fails to update, the factory default firmware update information can be used automatically to update the logic module 13 again.

Then, the step S206 is executed in which the logic module 13 outputs the valid power control signal S3 to the power conversion unit 12 to make the power conversion unit 12 output the second working power S4. Finally, the step S07 is executed in which the second logic unit 132 receives the second working power S4 to make the whole logic module 13 powered normally. Then, the computing system 1 can be started smoothly and the condition in accordance with the conventional art that the computing system fails to be started can be prevented.

In conclusion, by using the computing system as well as the power-on method and the updating method provided in accordance with the present invention, the problem of leaky current due to the comprehensive power-on process of the traditional computing system can be prevented because the present invention adopts the two-steps power-on process. In addition, the problem that the computing system cannot be smoothly started due to updating failure can also be prevented because the present invention adopts the two-steps updating process, which can trigger the updating step to use the predetermining firmware information when encountering updating failure in the first step so as to enhance user's convenience.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A computing system, comprising:
a power supply unit, utilized for receiving a system power and generating a first working power;
a power conversion unit, electrically connected to the power supply unit, utilized for receiving the first working power and outputting a second working power according to a power control signal;
at least a logic module, electrically connected to the power supply unit and the power conversion unit, and including at least a first logic unit and at least a second logic unit, the first logic unit being powered by the first working power, and the second logic unit being powered by the second working power;
a storage unit, electrically connected to the logic module, and storing at least an original predetermined firmware update information; and
a processing module, electrically connected to the logic module and the storage unit, for updating firmware of the logic module according to a updating instruction;
wherein, when the first logic unit is powered normally, the power-control signal transmitted from the logic module to the power conversion unit is valid to make the power conversion unit output the second working power, and the logic module is powered normally after the second logic unit receives the second working power;
wherein, when the processing module receives the updating instruction, the processing module transmits an application firmware signal to update the logic module, when the logic module fails to be updated, the power control signal transmitted from the logic module transmits to the power conversion unit is invalid to make the power conversion unit stop generating the second working power, and then the logic module is updated by the processing module automatically with the original predetermined firmware update information stored in the storage unit so as to transmit the valid power control signal to the power conversion unit to make the power conversion unit output the second working power, and the logic module is powered normally after the second logic unit receives the second working power again.

2. The computing system of claim 1, wherein the processing module is a baseboard management controller (BMC).

3. The computing system of claim 1, wherein the storage unit is a serial peripheral interface (SPI) read-only memory (ROM).

4. The computing system of claim 1, wherein the logic module is a complex programmable logic device (CPLD).

5. A power-on method, utilized for powering on the computing system of claim 1, comprising the steps of:
(a) determining whether the first logic unit is powered normally or not;
(b) as the determination of step (a) is yes, the logic module transmitting the valid power control signal;
(c) the power conversion unit receiving the valid power control signal to output the second working power; and
(d) the second logic unit receiving the second working power to make the logic module powered normally.

6. The power-on method of claim 5, wherein as the determination of the step (a) is no, a step (e) is executed to transmit an alarm signal.

7. A updating method, utilized for updating the computing system of claim 1, comprising the steps of:
(a) the processing module receiving the updating instruction and transmitting the application firmware signal to update the logic module
(b) determining whether the logic module fails to update;
(c) as the determination of step (b) is yes, the logic module transmitting the invalid power control signal;
(d) the power conversion unit receiving the invalid power control signal to stop the second working power;
(e) the processing module automatically updating the logic module with the original predetermined firmware update information stored in the storage unit;
(f) the logic module transmitting the valid power control signal to the power conversion unit to make the power conversion unit output the second working power; and
(g) the logic module being powered normally after the second logic unit receives the second working power again.
